(19) United States
(12) Patent Application Publication
(10) Pub. No.: US 2018/0354379 A1
(43) Pub. Date: Dec. 13, 2018

(54) PORTABLE AND MOBILE POWER SUPPLY FOR ELECTRIC CAR

(71) Applicant: SUZHOU DSM GREEN POWER LTD., Jiangsu (CN)

(72) Inventor: Walter WU, Jiangsu (CN)

(73) Assignee: SUZHOU DSM GREEN POWER LTD., Jiangsu (CN)

(21) Appl. No.: 15/768,689

(22) PCT Filed: Mar. 14, 2016
(86) PCT No.: PCT/CN2016/076303

§ 371 Date: Aug. 13, 2018

(30) Foreign Application Priority Data
Oct. 16, 2015 (CN) 201510667175.2

(51) Int. Cl. B60L 11/18; G07C 5/00; H04W 4/40; G06F 8/65

(52) U.S. Cl. CPC B60L 11/1822; B60L 11/1816; B60L 11/1861; G07C 5/008; B60L 2240/622; G06F 8/65; B60L 2270/40; B60L 2210/40; B60L 2210/10; H04W 4/40

(57) ABSTRACT

A portable and mobile power supply for an electric car. The power supply includes: a power generation unit (3); a system control and management module (15) configured to adjust an output power of the power generation unit, to output a direct current and a direct voltage capable of directly charging a power battery, to determine different charging control modes, to control the power generation output power of the power generation unit, and to control a charging voltage; a control panel (4) connected to the system control and management module; and a remote communication and GPS module (5) connected to the system control and management module, having a function of wireless remote communication and management and a function of supporting wireless positioning and switching by remote control, and being capable of remotely controlling the power generation unit to generate power and output the same to charge an in-vehicle power battery pack of an electric car. The present disclosure enables a more reliable, precise, and flexible use of the mobile power supply, and even allows monitoring of the charging state via a mobile phone app; in addition, a user can rent, via a member network, the mobile power supply when needing to use an electric car to travel a long distance, and then return the mobile power supply after use.

### TECHNICAL FIELD

The present disclosure relates to a vehicle-mounted and mobile auxiliary power supply for charging a power battery, which is used for a pure electric automobile and relates to the technical field of range-extended power system of a new energy vehicle.

### BACKGROUND

At present, there are two methods for extending the driving range of a pure electric vehicle: charging stations/stands and vehicle-mounted range-extended power generation systems. The charging station/stand require large investment and a long lead time for its construction; and the density of distribution of the charging stations/stands and the waiting time for charging greatly affects the purchase and the use of pure electric vehicles, which is the main reason why pure electric vehicles cannot develop in a commercial scale at the current stage. An effective solution is to add a vehicle-mounted range-extended power generation system to a pure electric vehicle, which alleviates the problem of short mileage of pure electric vehicles and excessively high price of the entire vehicle due to battery cost, and realizes pure electric power zero-emission mode for short-distance urban traffic and pure electrically driven range-extended mode for occasional long-distance trip, with unlimited mileage.

Chinese invention patent ZL201110245988.4 discloses a technology of an vehicle-mounted range-extended power generation system which enables a low-cost and high-efficiency vehicle-mounted power generation system to be directly installed on a pure electric vehicle, allows the power battery capacity to be reduced to a minimum required for the mileage of urban traffic, thereby significantly reducing the cost of the entire vehicle and while extends the driving range of the electric vehicle from being limited by the battery capacity. However, since most pure electric vehicles or a pure electric vehicle is used for short-distance urban traffic most of the time, if each electric vehicle is equipped with an vehicle-mounted range-extended power generation system, not only does the vehicle structure become complicated and maintenance costs increase, but the extra purchase cost of the entire vehicle and the additional vehicle weight offset the advantages of the pure electric vehicle, because most of the time, urban traffic will not require the vehicle-mounted extended-range power generation system.

Chinese invention patent ZL200610038539.1 discloses a technology of a digital power generation unit which is a portable conventional alternator with small volume and high integration. It is powered by a small petrol engine and can be used for household appliances or lighting to provide stable and reliable power in the event of a power outage. This simple alternator unit cannot meet the DC charging and control requirements of electric vehicles, cannot interface with automotive power batteries, and lacks the safety management capability and positioning capability of system remote monitoring and data recording.

Chinese invention patent ZL200610038539.1 discloses a technology of digital power generation unit, which is a mobile conventional alternator with small volume and high integration. It is powered by a small petrol engine and provides stable and reliable power for household appliances or lighting in the event of a power outage. This simple alternating current power generation unit cannot meet the direct current charging and control requirements of electric vehicles, cannot interface with automotive power batteries, and is short of the safety management capability and positioning capability such as system remote monitoring and data recording.

Patent application CN102957264A discloses a dual-frequency dual-voltage digital power generator which is a novel application capable of outputting four kinds of alternating current. The dual-frequency dual-voltage digital power generator comprises an engine, a three-phase permanent-magnet power generator, two three-phase rectifying and stabilizing modules, a voltage selection controller, a frequency selection switch, a direct-current and alternating-current conversion module and an LC low-pass filter. The dual-frequency dual-voltage digital power generator is characterized in that the three-phase permanent-magnet power generator comprises two three-phase high-voltage windings and one single-phase low-voltage winding, the two three-phase rectifying and stabilizing modules are used to output direct current signals which are connected in different connection modes, the direct-current and alternating-current conversion module acts on the direct current signals to output alternating current with different voltage, and frequency of output alternating current is optional. The digital generator lacks a system control and management module, a radiator fan, a control panel, a remote communication and GPS module, DC/DC module and a storage battery, etc. which cannot meet the direct current charging and control requirements of electric vehicles, cannot interface with automotive power batteries, and is short of the safety management capability and positioning capability such as system remote monitoring and data recording.

Patent application CN101672219 discloses a PWM control generator set comprising a multipolar generator, an engine whose output terminal is connected with an input terminal of the multipolar generator, and an AA-type frequency converter whose input terminal is connected with the output terminal of the multipolar generator; and the frequency conversion generator set is characterized in that a speed increaser is arranged between the output terminal of the engine and the input terminal of the multipolar generator. With the speed increaser arranged on the output terminal of the engine, the frequency conversion generator set increases speed of the engine, increases frequency of the generator so as to further reduce degree of wave distortion of voltage output by the AA-type frequency converter and allow the AA-type frequency converter to be effectively used in the frequency conversion generator set. However, the frequency conversion generator set is bulky and heavy, which is not suitable for being put into the trunk of automobile and is not suitable for being used as a mobile power supply. It cannot meet the direct current charging and control requirements of electric vehicles, cannot interface with automotive power batteries, and is short of the safety management capability and positioning capability such as system remote monitoring and data recording.

### SUMMARY

In view of the above-mentioned deficiencies in the prior art, the main object of the present disclosure is to provide a portable and mobile power supply for an electric vehicle. The mobile power supply can be placed in the trunk of a car and directly used to charge a power battery as needed when taken out of the car and placed on the ground, saving the need of driving the electric vehicle which is short of battery power while finding for rare charging stations, or waiting long in line at a charging station. In most cities where short-distance driving is required, backup power is not needed. In such case, the power supply can be taken off from the car and be put in the garage, which effectively reduces the weight of the vehicle. Remote monitoring can guarantee the safety and reliability of charging. Positioning and management capability can even relieve users from the need of buying a mobile power supply, and allows the users, when in need, to rent a mobile power supply, which effectively reduces the cost of use.

To achieve the above object, the present disclosure provides a technical solution of a portable and mobile power supply for an electric vehicle comprising a power generation unit that includes a direct current power device, a muffler, and an air filter;

a system control and management module connected to the power generation unit and configured to adjust output power of the power generation unit so as to output a direct current and a direct voltage capable of directly charging a power battery, automatically identify a type of power battery (lead-acid, lithium) for an electric vehicle and correctness of wirings, determine different charging control modes, and control power generation output power and output charging voltage of the power generation unit, and an output terminal of the system control and management module is connected to an alternating current socket and a direct current socket;

a control panel connected to the system control and management module;

a DC/DC module and a storage battery respectively connected to the control panel, and configured to provide starting and working power supply for the control system;

a remote communication and GPS module connected to the system control and management module, which has function of wireless remote communication and management, and a function of supporting wireless positioning and switching by remote control.

The mobile power supply is an integrated module with a handle. Fuel can be added through a fuel tiller port; and the status of the fuel is displayed on the control panel. The power generation unit is controlled by the control and management unit to generate power and output electricity to charge the electric vehicle-mounted power battery pack.

Preferably, the system control and management module is connected to and communicates with the remote communication and GPS module via RS232, is capable of receiving remote control commands such as a mute charging command, a system start/stop command, and a system lock command, and is capable of updating downloaded software, uploading system operating parameters of the system and outputting system monitoring status parameters including actual charging voltage, charging current, charging time, charging capacity, oil level, accumulated charging time, accumulated charging capacity, and error code. It supports a mobile app to monitor the charging status including the cumulative charging duration, accumulated charging energy, fuel information, and has a charging abnormality alarming function. It supports a subscription rental, remote troubleshooting, and power lock after loss through the mobile app.

Preferably, the control and management unit comprises a system management module and a power generation control module, control software in the system management module coordinates the power generation control module to control an output of direct current and direct voltage, the system management module is further capable of limiting a maximum charging current and providing protection against accidents such as external short circuit, polarity reversal or overvoltage.

Preferably, the system management module has a function to automatically identify a type of power battery for an electric vehicle, for example, lead-acid and lithium batteries, and to automatically select an appropriate charging control mode to charge the power battery.

Preferably, the system management module has two control modes, including a standby mode and a working mode. In the standby mode, the remote communication and GPS module is in a standby state for receiving a remote control command and the control and management unit is in a power-saving working mode. Only when the power lock position on the control panel is in the RUN position, the system is fully powered, allowing power generation and charging, and is in operating mode.

Preferably, the DC/DC module and the storage battery have an input terminal thereof connected with a direct current output terminal, so as to provide starting and working power supply for the control system. The DC/AC module is a passive direct current to alternating current power conversion module. Reduction in the actual alternating current charging capacity will cause the voltage at the direct current input terminal of the DC/AC module to rise. The system control and management module will regulate power generation of the power generation unit according to the detected direct current voltage.

Preferably, the portable and mobile power supply for an electric vehicle further comprises a fuel tank, a radiator fan, and a handle, the fuel tank being connected to the direct current power device, the radiator fan being installed outside the entire mobile power supply.

Preferably, the direct current power device is a gas generator, a fuel generator or a glycol ether generator.

Preferably, the direct current power device is a hydrogen fuel cell or a metal-air battery.

Preferably, the control panel comprises a plurality of control knobs and a touch control screen, which permits selection of a plurality of direct voltages for charging, battery types, direct current/alternating current output, and has a mute slow charging function.

Preferably, selectable direct current charging output voltages of the control panel include 60V, 72V, 96V, 144V, 320V, 360V, and 400V.

In the technical field of the present disclosure, the power output of the power generation unit is adjusted by the control and management unit and directly output to the power battery according to a set charging voltage. The charging current is adjusted in a standard constant current-constant voltage (CC-CV) charging mode. Before the charging starts, in order to ensure the safety of the system, the control and management unit first detects and determines the correct connection between the mobile power supply and the power battery (avoiding a short circuit or reverse polarity), and starts the power generation after detecting a correct battery voltage. Once the charging mode is detected to be set as mute/slow charging, the actual charging current will be reduced by 50% while the engine speed is reduced to reduce noise. if it is determined that the power battery is a lithium battery, the charging will be stopped when the charging current is less than 10% of the constant current rating. If it is determined that the power battery is a lead-acid battery, the charging current will be always maintained at the float voltage.

The beneficial effect of the present disclosure is that any pure electric vehicle can be equipped with a mobile power supply before a long journey, and the power battery can be charged at anytime and anywhere when the battery is lack of electricity, saving the need to look for a charging station or wait in line for charging at a charging station. The owner can monitor the charging process such as the mobile power supply fuel remain and the state of battery charging in real time through the mobile app. When needed, a mobile power supply for rental in the neighborhood can be found using the mobile app, which can be obtained by rental instead of purchase.

### BRIEF DESCRIPTION OF THE DRAWINGS

FIG. 1 is a schematic front view of the structure of the mobile power supply according to one embodiment of the present disclosure.

FIG. 2 is a schematic rear view of the structure of the mobile power supply according to one embodiment of the present disclosure.

FIG. 3 is a schematic diagram of the circuit structure of the control and management unit according to the present disclosure.

FIG. 4 is a flowchart of the main control software of the present disclosure.

### DESCRIPTION OF THE SYMBOLS

1. direct current power device; 2. power generation control module; 3. power generation unit; 4. control panel; 5. remote communication and GPS module; 6. DC/AC module; 7. DC/DC module; 8. Direct current socket; 9. Alternating current socket; 10. storage battery; 11. radiator fan; 12, fuel tank; 13, air filter; 14, muffler; 15, system control and management module.

### DETAILED DESCRIPTION

The preferred embodiments of the present disclosure will be described in detail with reference to the accompanying drawings so that the advantages and features of the present disclosure is more easily understood by those skilled in the art, thereby clearly defining the protection scope of the present disclosure.

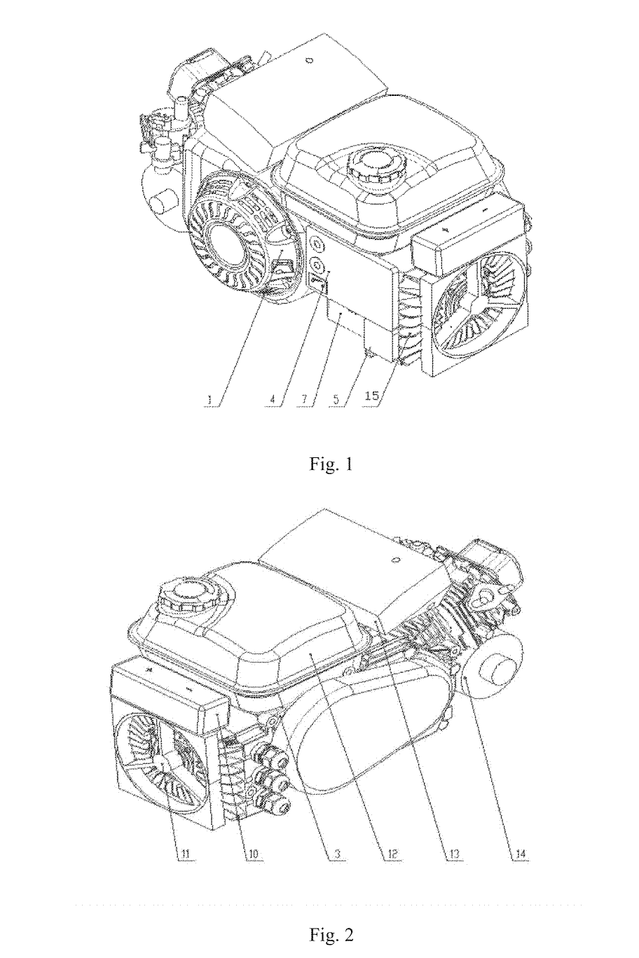

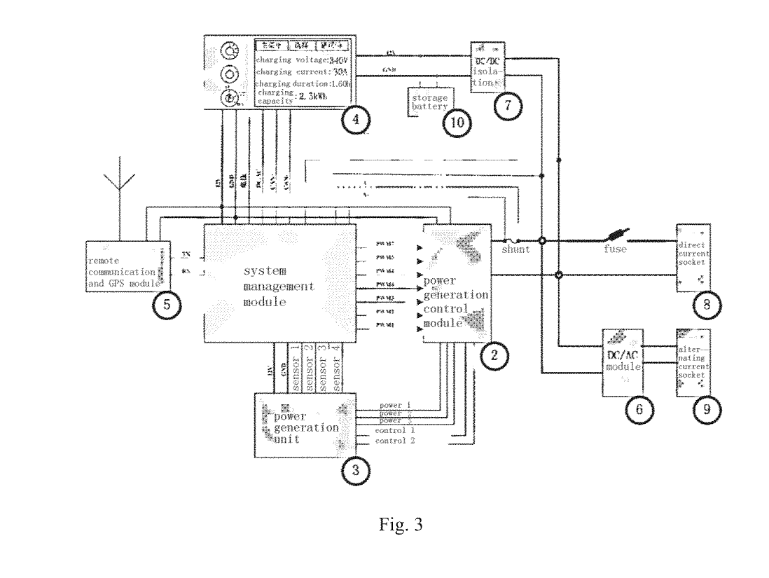

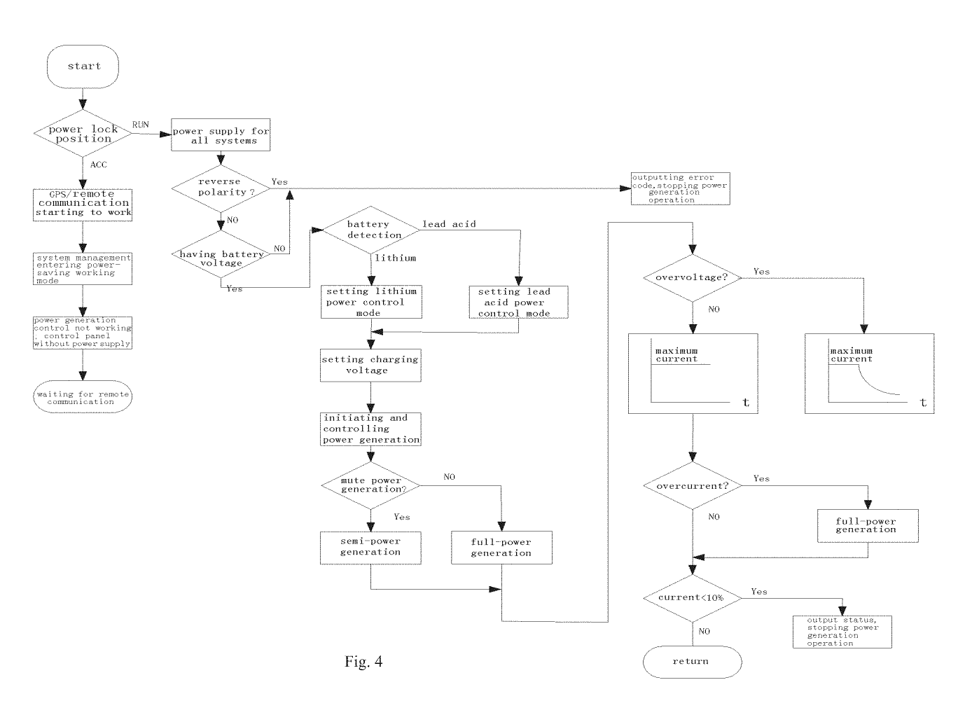

Referring to FIG. 1 to FIG. 4, it should be noted that the structures, proportions, sizes, etc., as shown in the drawings of this specification are only provided for cooperating with the contents disclosed in the present specification for those skilled in the art to understand and read, and are not intended to limit the limited conditions for implementing the disclosure of the present disclosure. Therefore, the structures, proportions, sizes, etc., as shown in the drawings are not technically significant. Any modification of the structure, change of the proportional relationship, or adjustment of the size without affecting the efficacy and the attainable purpose of the present disclosure should fall within the scope of the technical contents disclosed by the present disclosure. Meanwhile, the terms such as “upper”, “lower”, “left”, “right”, “intermediate”, and “one” are used in this specification only for the convenience of description, instead of limiting the scope of the implementation of the present disclosure. Changes or adjustments made to the relative relationship, without substantive changes in the technical content, should be considered as being in the scope in which the disclosure can be implemented.

As shown in FIGS. 1, 2, 3 and 4, the embodiments of the present disclosure include:

Embodiment 1: a portable and mobile power supply for an electric car comprising: a power generation unit 3 including a direct current power device 1, a muffler 14, and an air filter 13;

a system control and management module 15 which is connected to the power generation unit 3 and is configured to adjust the output power of the power generation unit 3 and which outputs a direct current and a direct voltage for directly charging the power battery, automatically identifies a type of automotive power battery (lead-acid or lithium-ion), correctness of wiring, determines different charging control modes, and controls the power generation output power and output charging voltage of the power generation unit 3;

a control panel 4 connected with the system control and management module 15;

a DC/DC module 7 and a storage battery 10 which are connected to the control panel 4 and a direct current output terminal of the power generation control module 2, respectively, for providing starting and working power supply for the control system;

wherein the output terminal of the power generation control module 2 is connected with an alternating current socket 9 and a direct current socket 8 via the DC/AC module 6, the direct current socket 8 being adapted for a standard charging plug and the alternating current socket 9 being a standard power output socket.

A remote communication and GPS module 5 are connected to the system control and management module 15, which has a wireless remote communication and management function and supports a function of wireless positioning and switching by remote control.

The mobile power supply is an integrated module with a handle. Fuel can be added to the fuel tank 12 through a fuel filler port, with the status of the fuel displayed on the control panel 4. The power generation unit 3 is controlled by the system control and management module 15 to generate and output power for charging a battery package of an electric vehicle-mounted power battery pack.

In this embodiment, the system control and management module 15 and the remote communication and GPS module 5 perform communication connection via RS232, including receiving remote control commands such as a mute charging command, a system start/stop command, a system lock command, etc., and may update downloaded software and upload system operating parameters, output system monitoring status parameters such as actual charging voltage, charging current, charging duration, charging capacity, oil level, accumulated charging duration, accumulated charging capacity, error code, etc.

In this embodiment, the system control and management module 15 simultaneously monitors real-time signal status and CAN communication data of each sensor, including sampling charging voltage selection signals and battery type setting signals from the control panel 4, monitoring actual charging voltage and charging current, and sampling signals of the power generation unit 3 such as temperature and motor position signals, and at the same time, through CAN communication, outputs system error code and charging status information to the control panel 4 or accepts information of a part of operations to the control panel 4 including mute setting and password setting.

In this embodiment, the system control and management module 15 is capable of monitoring mobile app to monitor the charging status through the remote communication and GPS module 5, including the accumulated charging duration, the accumulated charging power, the oil level information, and the charging abnormality alarming function. It supports subscription rental, remote troubleshooting, and power lock after loss through the mobile app.

In this embodiment, the direct current power device is a fuel generator.

Embodiment 2: this embodiment is different from Embodiment 1 in that the control and management unit 15 comprises a system management module and a power generation control module 2. Control software in the system management module coordinates the power generation control module 2 to control the output direct current and direct voltage. The system management module is also capable of limiting the maximum charging current and provides protection against accidents such as external short circuit, polarity reversal and overvoltage.

In this embodiment, the power generation control module 2 receives three-phase power output from the power generation unit 3 and directly outputs a direct current charging current after rectification, and controls the generator excitation current to adjust the actual power generation direct current output. The excitation source is from the target charging power battery. The storage battery 10 is charged by the DC/DC 7 and provides transient power during engine start-up and ignition, and provides a standby power during standby of the mobile power supply, and supports remote communication and positioning functions. When the power lock on the control panel 4 is in an OFF position, the mobile power supply is in a fully closed state; when the power lock is in an ACC position, the mobile power supply is in a standby state and supports remote communication and positioning; only when the power lock is in the RUN position can the mobile power supply generate electricity to provide charging power source.

In this embodiment, the system management module can automatically identify the type of a power battery of an electric vehicle, such as lead-acid, lithium, etc., and automatically select an appropriate charging control mode to charge the power battery.

In this embodiment, a flexible pulley connection between the engine and the generator is used to reduce vibration conduction.

Embodiment 3: This embodiment is differed from Embodiment 1 in that the output terminal of the DC/DC module 7 and the storage battery 10 described in this embodiment is connected to the control panel 4, and the direct current output terminal of the power generation control module 2 is connected to the DC/AC module 6, the DC/AC module 6 being a passive direct current to alternating current power conversion module.

The alternating current output DC/AC module 6 described in this embodiment is a passive power conversion module and is an optional plug-in. When the alternating current charging power decreases, the direct current input terminal voltage will increase. The system control and management module 15 performs power generation adjustment on the power generation unit according to the detected direct voltage. In this embodiment, if the system control and management module 15 detects that a selection command from a remote command or from the control panel 4 requires mute charging, the system control and management module 15 will reduce the charging power by 50% and reduce the engine speed for the purpose of reducing noise.

Embodiment 4: this embodiment is different from Embodiment 1 in that the portable and mobile power supply for an electric car in this embodiment further includes a fuel tank 12, a radiator fan 11, and a handle, the fuel tank 12 being connected to the internal combustion engine 1, the radiator fan 11 being mounted on an outer side of the entire mobile power supply.

Embodiment 5: this embodiment is different from Embodiment 1 in that the direct current power device in this embodiment is a hydrogen fuel cell or a metal-air battery.

Embodiment 6: this embodiment is different from Embodiment 1 in that, in this embodiment, the control panel 4 has multiple control knobs and a touch control screen, and various output direct voltages for charging can be selected, for example, 60V, 72V, 96V, 144V, 320V, 360V, 400V, etc., and the battery type such as lead-acid, lithium battery, direct current or alternating current output, and a mute slow charging and other functions can be selected as well.

Embodiment 7: this embodiment is different from Embodiment 1 in that the direct current socket in this embodiment supports direct current output charging and is replaceable, satisfying multiple standard electric vehicle charging interface standards.

Embodiment 8: this embodiment is different from Embodiment 1 in that the system management module has two control modes, including a standby mode and a working mode. In the standby mode, the remote control and GPS module 5 is in a standby state for receiving the remote control command while the system control and management module 15 is in a power saving working mode. Only when the power lock is in the RUN position on the control panel 4, the system is fully powered and allows power generation and charging, which is in the working mode.

In the work mode, the system management module constantly monitors the correctness of the direct current bus voltage and current. If the polarity of the external direct current power line is detected to be reversed or short-circuited (without voltage), a wiring error will be determined, and an error code is sent and the operation ceases. When normal work begins, first, the system management module performs a system initialization operation, including setting a charging voltage and a charging mode (lithium or lead-acid), etc. If there is a mute charging request, the charging current is set to 50% of the rated charging current while the engine speed is reduced. The power generation process is a closed-loop control process. The initial generation current is the maximum (constant-current charging-CC); and the voltage continuously rises as the charging continues. When the voltage reaches the set rated charging voltage, the closed-loop control charging current decreases continuously to keep the charging voltage constant (constant-voltage charging-CV) till the actual charging current is reduced to less than 10% of the maximum rated current where the charging ends and the system shuts down.

As described above, the present disclosure provides a portable and mobile power supply for an electric car. Any pure electric vehicle can be equipped with a mobile power supply before driving for a long distance. When the battery lacks power, the vehicle can be parked anytime anywhere to charge the power battery, saving the need of finding a charging station or waiting in line at the charging station for charging. The car owner can monitor in real time the charging process through the mobile app, including the remaining fuel level of the mobile power supply and the charging state of the battery. When needed, a mobile power supply for rental in the neighborhood can be found using the mobile app, which can be obtained by rental instead of purchase. Therefore, the present disclosure effectively overcomes various shortcomings in the prior art and has high industrial utility value.

The above-described embodiment merely exemplifies the principles and effects of the present disclosure, and is not intended to limit the present disclosure. Any person skilled in the art can make modifications or changes to the above embodiments without departing from the spirit and scope of the present disclosure. Therefore, all equivalent modifications or changes made by any person with ordinary skill in the art without departing from the spirit and technical thought disclosed in the present disclosure shall still be covered by the claims of the present disclosure.

1. A portable and mobile power supply for an electric vehicle, comprising:
a power generation unit comprising a direct current power device;
a system control and management module connected to the power generation unit and configured to adjust output power of the power generation unit so as to output a direct current and a direct voltage capable of directly charging a power battery;
a control panel connected to the system control and management module;
a DC/DC module and a storage battery respectively connected with the control panel and configured to provide starting and working power supply for the control panel and the system control and management module; and
a remote communication module connected to the system control and management module, which has a function of wireless remote communication.

2. The portable and mobile power supply for an electric vehicle according to claim 1, wherein the system control and management module is connected to and communicates with the remote communication module via RS232, is capable of receiving remote control command, and is capable of updating downloaded software, uploading a system operating parameter, and outputting a system monitoring status parameter.

3. The portable and mobile power supply for an electric vehicle according to claim 1, wherein the system control and management module comprises a system management module and a power generation control module, control software in the system management module coordinates the power generation control module to control the output direct current and direct voltage, the system management module is further capable of limiting a maximum charging current and providing protection against accidents of external short circuit, polarity reversal or overvoltage.

4. The portable and mobile power supply for an electric vehicle according to claim 3, wherein the system management module is capable of automatically identifying the type of the power battery for the electric vehicle, and to automatically selecting an appropriate charging control mode according to the identified type of the power battery to charge the power battery.

5. The portable and mobile power supply for an electric vehicle according to claim 3, wherein the system management module has two control modes including a working mode and a standby mode in which the remote communication module is in a standby state for receiving a remote control command, and the system control and management module is in a power-saving working mode.

6. The portable and mobile power supply for an electric vehicle according to claim 1, wherein a direct current output terminal of the system control and management module is connected to a DC/AC module, and the DC/AC module is a passive direct current to alternating current power conversion module.

7. The portable and mobile power supply for an electric vehicle according to claim 1, further comprising a fuel tank, a radiator fan, and a handle, the fuel tank being connected to the direct current power device, the radiator fan being installed outside the entire mobile power supply.

8. The portable and mobile power supply for an electric vehicle according to claim 1, wherein the direct current power device is a gas generator, a fuel generator, an alcohol ether generator, a hydrogen fuel cell, or a metal-air battery.

9. The portable and mobile power supply for an electric vehicle according to claim 1, wherein the control panel comprises a plurality of control knobs and a touch control screen, which allow selection of a plurality of direct voltages for charging, battery types, direct current output or alternating current output, and a mute slow charging function.

10. The portable and mobile power supply for an electric vehicle according to claim 1, wherein the system control and management module is capable of automatically identifying correctness of wirings between the mobile power supply and the power battery.

11. The portable and mobile power supply for an electric vehicle according to claim 1, wherein an output terminal of the system control and management module is connected to an alternating current socket and a direct current socket.

12. The portable and mobile power supply for an electric vehicle according to claim 1, wherein the remote communication module further has a function of supporting wireless positioning and switching by remote control.

13. The portable and mobile power supply for an electric vehicle according to claim 2, wherein the remote control command includes a mute charging command, a system start/stop command, or a system lock command.

14. The portable and mobile power supply for an electric vehicle according to claim 2, wherein the system monitoring status parameter includes actual charging voltage, charging current, charging time, charging capacity, oil level, accumulated charging time, accumulated charging capacity, or error code.
